(19) United States
(12) Patent Application Publication
(10) Pub. No.: US 2016/0224120 A1
(43) Pub. Date: Aug. 4, 2016

(54) VIRTUAL REMOTE CONTROL APPARATUS AND METHOD THEREOF

(71) Applicant: DAEGU GYEONGBUK INSTITUTE OF SCIENCE AND TECHNOLOGY, Daegu (KR)

(72) Inventors: Myoung-Kyu Sohn, Daegu (KR); Sang-Heon LEE, Deagu (KR); Dongju KIM, Gyeongsangnam-do (KR); Hyunduk Kim, Daegu (KR)

(73) Assignee: Daegu Gyeongbuk Institute of Science and Technology, Daegu (KR)

(21) Appl. No.: 14/917,949

(22) PCT Filed: Aug. 13, 2014
(86) PCT No.: PCT/KR2014/007510

§ 371 Date: Mar. 10, 2016

(30) Foreign Application Priority Data
Oct. 8, 2013 (KR) 10-2013-0119878

(51) Int. Cl. G06F 3/01; G06F 3/16; G06F 3/00; G06T 7/00; G06K 9/00; G06T 7/20; G06T 7/40

(52) U.S. Cl. CPC G06F 3/017; G06T 7/20; G06F 3/167; G06T 7/408; G06T 7/004; G06K 9/00355; G06F 3/005; G06T 2207/30196

(57) ABSTRACT

A virtual remote control apparatus for controlling an electronic device, including: a photographed information collection unit which receives photographed information from the a photography device; a user detection unit which detects a motion of a user by analyzing the photographed information; a hand motion recognition unit which recognizes a first hand of both hands as a panel and a second hand as a control means by analyzing the photographed information, and creates control information according to a movement of the control means placed above the panel; and a control unit which operates the hand motion recognition unit when sensing information that informs detection of the user is received from the user detection unit, creates a control command corresponding to the control information received from the hand motion recognition unit so as to control the electronic device.

### TECHNICAL FIELD

Apparatuses and methods consistent with the present invention relate to a virtual remote control, and more particularly, to a virtual remote control apparatus which can accurately control electronic devices with user's both hands in the space and a method thereof.

### BACKGROUND ART

Recently, a remote control apparatus is applied even to a mobile terminal, so a user can more conveniently control peripheral electronic devices by using the mobile terminal.

A recent terminal such as a smart phone, a PDA (personal digital assistant) and etc. can control menu items or command icons through a simple touch of a touch screen.

However, there is an inconvenience that the user should always carry the mobile terminal to control electronic devices. To solve such an inconvenience, researches for user interface which can recognize hand motions or particular gestures and control the electronic devices by using the recognized motions or gestures have been undertaken.

Motion recognition technology can control the electronic devices by recognizing a user's hand (or hands), finding a coordinate or a position of the end of a finger, and then moving a cursor on the screen according to a track of the hand.

However, the known technology has a problem of inaccuracy since the electronic devices are controlled only through recognition of the finger in the space without an additional panel.

The background art of the present invention is disclosed in the Korean Patent Laid-Open Publication No. 10-2011-0097504 (laid-open on Aug. 31, 2011).

### DISCLOSURE

### Technical Problem

The present invention has been made in an effort to provide a virtual remote control apparatus which can accurately control electronic devices with user's both hands in the space and a method thereof.

### Technical Solution

An exemplary embodiment of the present invention provides a virtual remote control apparatus for controlling an electronic device, which may include: a photographed information collection unit which receives photographed information from the a photography device; a user detection unit which detects a motion of a user by analyzing the photographed information; a hand motion recognition unit which recognizes a first hand of both hands as a panel and a second hand as a control means by analyzing the photographed information, and creates control information according to a movement of the control means placed above the panel; and a control unit which operates the hand motion recognition unit when sensing information that informs detection of the user is received from the user detection unit, creates a control command corresponding to the control information received from the hand motion recognition unit so as to control the electronic device.

The user detection unit may calculate image variation values in color and luminance for each time from the photographed information, recognize the user when a calculated image variation value exceeds a threshold value, and create sensing information.

The hand motion recognition unit may estimate a distance value between the first and second hands, and if the estimated distance value is equal to or less than a predetermined value, create the control information according to a movement of the second hand placed above the first hand. The hand motion recognition unit may determine whether the motion of the second hand placed above the first hand corresponds to a previously registered hand motion having a predetermined value, and if the motion corresponds the previously registered motion, create the control information including the predetermined value which corresponds to the motion of the second hand placed above the first hand.

The control unit to which the control information is transmitted may supply a notification corresponding to the control information by using a voice output means capable of outputting voices or a display means such as an LED (light emitting diode) or an LCD (liquid crystal display).

Another exemplary embodiment of the present invention provides a method for remotely controlling an electronic device by using a virtual remote control apparatus, which may include: receiving photographed information from the a photography device which photographs an image; detecting a motion of a user by analyzing the photographed information; recognizing a first hand of both hands as a panel and a second hand as a control means by analyzing the photographed information, and creating control information according to a movement of the control means placed above the panel; and receiving sensing information, recognizing the user from the sensing information, and creating a control command corresponding to the control information so as to control the electronic device.

### Advantageous Effects

According to embodiments of the present invention, it is possible to remotely control electronic devices in the space with high accuracy by recognizing one hand as a panel and gesturing with the other hand placed above the panel.

### DESCRIPTION OF DRAWINGS

FIG. 1 shows a system to which a virtual remote control apparatus according to an exemplary embodiment of the present invention is applied.

FIG. 2 is a block diagram showing a scheme of the virtual remote control apparatus according to the exemplary embodiment of the present invention in detail.

FIG. 3 is a flow chart showing a control method of the virtual remote control apparatus according to the exemplary embodiment of the present invention.

FIG. 4 shows functions of the left hand, which are recognized by the virtual remote control apparatus according to the exemplary embodiment of the present invention.

FIG. 5 shows hand motions which are recognized by the virtual remote control apparatus according to the exemplary embodiment of the present invention.

### BEST MODE

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive, and like reference numerals designate like elements throughout the specification.

In addition, unless explicitly described to the contrary, the word “comprise” and variations such as “comprises” or “comprising” will be understood to imply the inclusion of stated elements, but not the exclusion of any other elements.

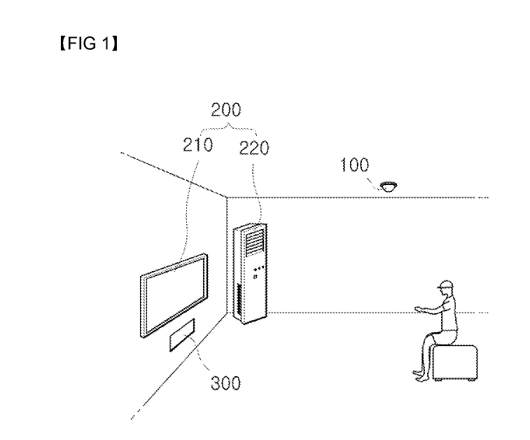

Hereinafter, a virtual remote control apparatus according to an exemplary embodiment of the present invention will be described in detail with reference to FIG. 1 to FIG. 5.

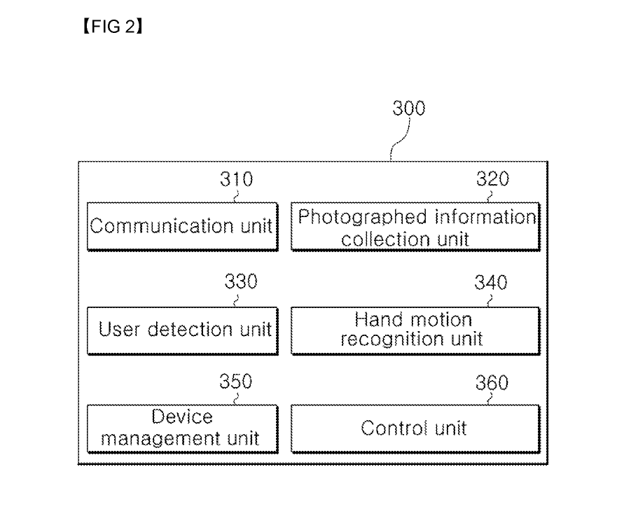

FIG. 1 shows a system to which a virtual remote control apparatus according to an exemplary embodiment of the present invention is applied, and FIG. 2 is a block diagram showing a scheme of the virtual remote control apparatus according to the exemplary embodiment of the present invention in detail.

Referring to FIG. 1, a virtual remote control system according to an exemplary embodiment of the present invention is applied includes a photography device 100, electronic devices 200, and a virtual remote control apparatus 300.

The photography device 100 includes a device which can photograph 3-dimentional (3D) images, such as a camera. The photography device 100 creates information about user's motions photographed by the camera, and then transmits the information to the virtual remote control apparatus 300.

In this case, the photography device 100 photographs images of a place where the user is located, and then transmits information about the photographed images to the virtual remote control apparatus 300.

The electronic devices 200 include home appliances, such as a television 210 and an air conditioner 220. The electronic devices 200 are connected with the virtual remote control apparatus 300 to receive control commands therefrom.

The virtual remote control apparatus 300 recognizes the user on the basis of the information transmitted from the photography device 100, and controls the electronic devices 200 according to a hand motion of the recognized user.

Referring to FIG. 2, the virtual remote control apparatus 300 includes a communication unit 310, a photographed information collection unit 320, a user detection unit 330, a hand motion recognition unit 340, a device management unit 350, and a control unit 360.

The communication unit 310 receives and transmits data, communicating with the photography device 100 and the electronic devices 200. In detail, the communication unit 310 receives the photographed information from the photography device 100, and transmits the received information to the photographed information collection unit 320. In addition, the communication unit 310 transmits a control command transmitted from the device management unit 350 to the electronic devices 200.

In this case, the communication unit 310 performs data-communication with the photography device 100 and the electronic devices 200 by using a local wireless communication, such as Bluetooth, Wi-Fi and Zigbee, or a wired communication.

The photographed information collection unit 320 receives the photographed information from the photography device 100 through the communication unit 310, and transmits the received information to the user detection unit 330 and the hand motion recognition unit 340 according to the control of the control unit 360.

In this case, the photographed information collection unit 320 may manage the photographed information by temporarily storing the information therein in chronological order.

The user detection unit 330 analyzes the photographed information transmitted from the photographed information collection unit 320 in real time, calculates variation values in the photographed images (for example, color values, luminance values, etc.) by utilizing the photographed information, determines whether the calculated variation value exceeds a predetermined threshold value or not, and then creates sensing information. In this case, if the variation value in the photographed images exceeds the predetermined threshold value, the user detection unit 330 determines that the user has been detected, and creates the sensing information.

In addition, the user detection unit 330 transmits the created sensing information to the control unit 360.

The hand motion recognition unit 340 analyzes the photographed information transmitted from the photographed information collection unit 320 in real time, and creates control information for controlling the electronic devices 200 when it recognizes the hand motion of the user in the photographed information.

In detail, the hand motion recognition unit 340 creates the control information by sensing motions of both hands in the photographed information. In further detail, regarding the left hand and the right hand as a panel and a control means, respectively, the hand motion recognition unit 340 creates the control information corresponding to the user's hand motions. In this case, the hand motion recognition unit 340 recognizes the left hand in advance of the right hand, estimates a distance value between the both hands, and if the estimated distance value is equal to or less than a predetermined value, creates the control information corresponding to the motion of the right hand which is placed above the left hand functioning as the panel.

In the above, the present invention has been described on the assumption that the hand motion recognition unit 340 respectively recognizes the left and right hands as the panel and the control means. However, in the present invention, the right hand may be used as the panel and the left hand may be used as the control means.

The device management unit 350 performs state management for a plurality of the electronic devices 200, transmits the control command transmitted from the control unit 360 to the electronic devices 200, and then transmits a response to the control command to the control unit 360.

In this case, the device management unit 350 transmits the control command to the electronic devices 200 through the communication unit 310, and receives the response therethrough.

The control unit 360 controls the respective units 310, 320, 330, 340 and 350, changes a power-saving mode to a common mode when the sensing information is received from the user detection unit 330, and then operates the hand motion recognition unit 340.

Then, the control unit 360 creates the control command corresponding to the control information received from the hand motion recognition unit 340, and transmits the control command the device management unit 350.

Meanwhile, the virtual remote control apparatus 300 according to the exemplary embodiment of the present invention may further include a voice output means and a display means. In this case, the voice output means (not shown) may include a speaker or the like, which can output previously stored voices according to the control of the control unit 360, and the display means (not shown) may include an LED (light emitting diode), an LCD (liquid crystal display) or the like, which can display particular information according to the control of the control unit 360.

The control unit 360 informs the user of the control information transmitted from the hand motion recognition unit 340 by using the voice output means (not shown) or the display means (not shown), changes the control information to the control command when the control information is approved by the user, and then transmits the control command to the device management unit 350.

The virtual remote control apparatus 300 according to the present invention may be advantageous in that it can remotely control the electronic devices 200 with high accuracy by recognizing one hand as a panel and the other as a control means placed above the panel.

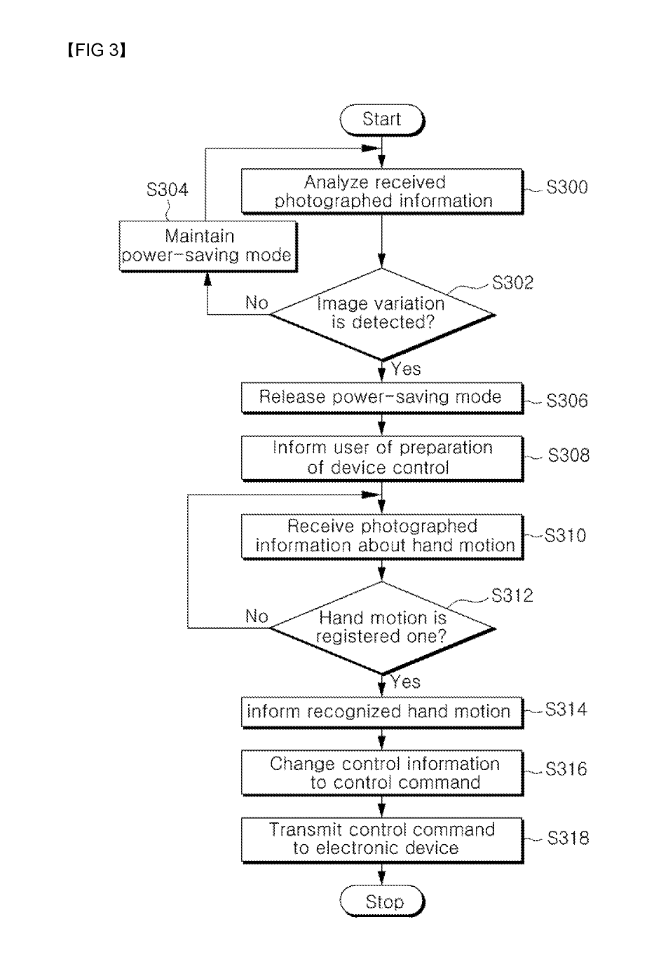

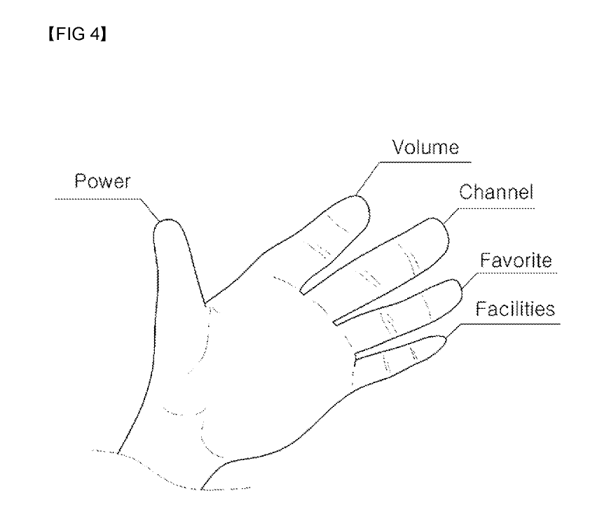

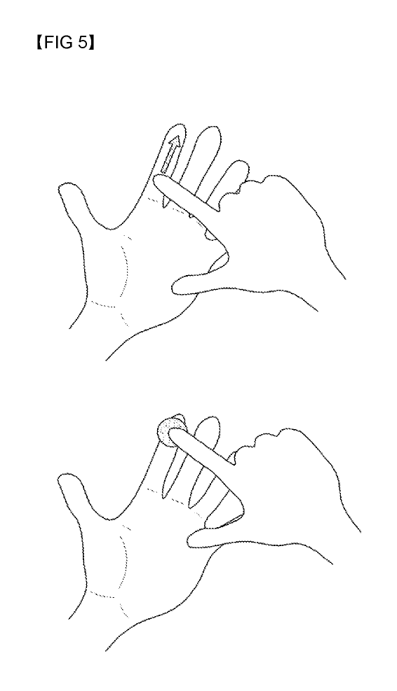

FIG. 3 is a flow chart showing a control method of the virtual remote control apparatus according to the exemplary embodiment of the present invention, FIG. 4 shows functions of the left hand, which are recognized by the virtual remote control apparatus according to the exemplary embodiment of the present invention, and FIG. 5 shows examples of hand motions which are recognized by the virtual remote control apparatus according to the exemplary embodiment of the present invention.

Referring to FIG. 3, the control unit 360 of the virtual remote control apparatus 300 according to the exemplary embodiment of the present invention performs the power-saving mode if the user is not detected.

The photography device 100 photographs images of a random spot, and transmits information about the photographed images to the virtual remote control apparatus 300.

The user detection unit 330 analyzes the photographed information transmitted from the photography device 100 through the communication unit 310 at step S300, and determines whether an image variation in the photographed information is detected or not at step S302.

In detail, the user detection unit 330 analyzes the photographed information transmitted from the photography device 100 in real time, calculates variation values in the photographed images (for example, color values, luminance values, etc.) based on the analyzed information, and then determines whether the calculated image variation value exceeds a predetermined threshold value or not.

Various techniques capable of sensing the user through the photographed information have been already disclosed in the art, so a detailed description of those techniques omits in the exemplary embodiment of the present invention.

The user detection unit 330 maintains the power-saving mode if the calculated image variation value does not exceed the predetermined threshold value as a result of determination in the step S302, and repeatedly performs the steps S300 and S302.

If the calculated image variation value exceeds the predetermined threshold value as a result of determination in the step S302, the user detection unit 330 creates the sensing information informing that the user has been recognized, and transmits the created sensing information to the control unit 360.

Then, when receiving the sensing information from the user detection unit 330, the control unit 360 releases the power-saving mode at step 306, and starts an operation of the common mode. Simultaneously, the control unit 360 operates the hand motion recognition unit 340.

Then, at step S308, the control unit 360 informs the user that the control for the electronic devices 299 gets ready by using the voice output means (not shown) and the display means (not shown) included in the virtual remote control apparatus 300.

The hand motion recognition unit 340 receives the photographed information from the photographed information collection unit 320 at step 310. Then, at step S312, the hand motion recognition unit 340 recognizes the hand motion by analyzing the received information, and determines whether the recognized hand motion corresponds to a previously registered hand motion having a predetermined value.

In detail, when detecting motions of both hands in the photographed information, the hand motion recognition unit 340 regards the left hand as a panel and the right hand as a control means. Then, the hand motion recognition unit 340 estimates a distance value between the both hands, and if the estimated distance value is equal to or less than the predetermined value, determines whether the hand motion corresponds to the registered hand motion having the previously registered value or not by checking the motion of the right hand placed above the left hand (functioning as the panel).

If the motion of the right hand does not have the previously registered value as a result of the determination in the step S312, the hand motion recognition unit 340 repeatedly performs the steps S310 and S312 till it receives the hand motion having the previously registered value. In this case, the hand motion recognition unit 340 requests the control unit 360 that the user performs the hand motion again, and the control unit 360 may request the user to gesture again through the voice output means (not shown) and display means (not shown).

As a result of the determination in the step S312, if the hand motion has the previously registered value, the hand motion recognition unit 340 creates control information including the predetermined value which corresponds to the recognized hand motion at step 314.

Referring to FIG. 4, the hand motion recognition unit 340 according to the present invention has the predetermined values for the left hand, creates the control information for the predetermined values of the left hand according to the motions of the right hand, and transmits the control information to the control unit 360. For example, the predetermined values may be set in a way that the thumb is Power, the forefinger is Volume, the middle finger is Channel, the third finger is Favorite, and the little finger is Facilities.

Referring to FIG. 5, recognizing the left hand as the panel and the right hand as the control means, the hand motion recognition unit 340 creates the control information based on the predetermined values which correspond to the motions of the right fingers placed above the left fingers. For example, in the case in which a finger of the right hand moves toward an end portion of the forefinger of the left hand or touches the end portion of the forefinger, the hand motion recognition unit 340 recognizes such a case as the volume should be lowered, and then creates the control information corresponding to the recognized information.

The control unit 360 receives the control information from the hand motion recognition unit 340, and informs the user of the recognized hand motion according to the received control information at step S314.

Then, the control unit 360 changes the received control information to a control command for controlling the electronic devices 200 at step 316, and transmits the control command to the electronic devices 200 at step S318.

The virtual remote control apparatus 300 according to the present invention has an advantage that it can remotely control the electronic devices 200 with high accuracy by recognizing one hand as the panel and the other as the control means placed above the panel.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A virtual remote control apparatus for controlling an electronic device, comprising:
a photographed information collection unit which receives photographed information from the a photography device;
a user detection unit which detects a motion of a user by analyzing the photographed information;
a hand motion recognition unit which recognizes a first hand of both hands as a panel and a second hand as a control means by analyzing the photographed information, and creates control information according to a movement of the control means placed above the panel; and
a control unit which operates the hand motion recognition unit when sensing information that informs detection of the user is received from the user detection unit, creates a control command corresponding to the control information received from the hand motion recognition unit so as to control the electronic device.

2. The virtual remote control apparatus of claim 1, wherein the user detection unit calculates image variation values in color and luminance for each time from the photographed information, recognizes the user when a calculated image variation value exceeds a threshold value, and creates sensing information.

3. The virtual remote control apparatus of claim 2, wherein the hand motion recognition unit estimates a distance value between the first and second hands, and if the estimated distance value is equal to or less than a predetermined value, creates the control information according to a movement of the second hand placed above the first hand.

4. The virtual remote control apparatus of claim 3, wherein the hand motion recognition unit determines whether the motion of the second hand placed above the first hand corresponds to a previously registered hand motion having a predetermined value, and if the motion corresponds the previously registered motion, creates the control information including the predetermined value which corresponds to the motion of the second hand placed above the first hand.

5. The virtual remote control apparatus of claim 1, wherein the control unit to which the control information is transmitted supplies a notification corresponding to the control information by using a voice output means capable of outputting voices or a display means such as an LED (light emitting diode) or an LCD (liquid crystal display).

6. A method for remotely controlling an electronic device by using a virtual remote control apparatus, comprising:
receiving photographed information from the a photography device which photographs an image;
detecting a motion of a user by analyzing the photographed information;
recognizing a first hand of both hands as a panel and a second hand as a control means by analyzing the photographed information, and creating control information according to a movement of the control means placed above the panel; and
receiving sensing information, recognizing the user from the sensing information, and creating a control command corresponding to the control information so as to control the electronic device.

7. The method of claim 6, wherein the detecting of the motion includes:
calculating image variation values in color and luminance for each time from the photographed information; and
creating the sensing information when a calculated image variation value exceeds a threshold value.

8. The method of claim 7, wherein the creating of the control information includes:
estimating a distance value between the first and second hands; and
creating the control information according to a movement of the second hand placed above the first hand when the estimated distance value is equal to or less than a predetermined value.

9. The method of claim 7, wherein the creating of the control information includes:
estimating a distance value between the first and second hands; and
creating the control information according to a movement of the second hand placed above the first hand when the estimated distance value is equal to or less than a predetermined value.

10. The method of claim 6, further comprising a step of supplying a notification corresponding to the control information by using a voice output means capable of outputting voices or a display means such as an LED (light emitting diode) or an LCD (liquid crystal display) when the control information is transmitted.

11. The virtual remote control apparatus of claim 2, wherein the control unit to which the control information is transmitted supplies a notification corresponding to the control information by using a voice output means capable of outputting voices or a display means such as an LED (light emitting diode) or an LCD (liquid crystal display).

12. The virtual remote control apparatus of claim 3, wherein the control unit to which the control information is transmitted supplies a notification corresponding to the control information by using a voice output means capable of outputting voices or a display means such as an LED (light emitting diode) or an LCD (liquid crystal display).

13. The virtual remote control apparatus of claim 4, wherein the control unit to which the control information is transmitted supplies a notification corresponding to the control information by using a voice output means capable of outputting voices or a display means such as an LED (light emitting diode) or an LCD (liquid crystal display).

14. The method of any one of claim 7, further comprising a step of supplying a notification corresponding to the control information by using a voice output means capable of outputting voices or a display means such as an LED (light emitting diode) or an LCD (liquid crystal display) when the control information is transmitted.

15. The method of any one of claim 8, further comprising a step of supplying a notification corresponding to the control information by using a voice output means capable of outputting voices or a display means such as an LED (light emitting diode) or an LCD (liquid crystal display) when the control information is transmitted.

16. The method of any one of claim 9, further comprising a step of supplying a notification corresponding to the control information by using a voice output means capable of outputting voices or a display means such as an LED (light emitting diode) or an LCD (liquid crystal display) when the control information is transmitted.
